(19) United States
(12) Patent Application Publication
(10) Pub. No.: US 2025/0310587 A1
(43) Pub. Date: Oct. 2, 2025

(54) SYSTEM AND METHOD FOR CREATING A VIRTUAL CHANNEL

(71) Applicant: ThinkAnalytics Ltd., Glasgow (GB)

(72) Inventors: Asim Ullah, Glasgow (GB); Bryan Bossard, Canyon Country, CA (US); Ewen Cattanach, Glasgow (GB); Harrison Ghatoray, Glasgow (GB); Peter Docherty, Glasgow (GB); Christopher McGuire, Glasgow (GB)

(73) Assignee: ThinkAnalytics Ltd., Glasgow (GB)

(21) Appl. No.: 18/622,379

(22) Filed: Mar. 29, 2024

(51) Int. Cl. H04N 21/2668; H04N 21/25; H04N 21/258; H04N 21/262; H04N 21/431; H04N 21/472; H04N 21/482

(52) U.S. Cl. CPC H04N 21/2668; H04N 21/251; H04N 21/25891; H04N 21/26283; H04N 21/431; H04N 21/47202; H04N 21/4826

(57) ABSTRACT

A computer-implemented method and system for creating a virtual channel based on linear broadcast content, is disclosed. The method comprises obtaining scheduling information and content information associated with a plurality of content items in a content schedule for two or more existing channels, the content information comprising at least an identifier for each content item; determining, for each timeslot in a predetermined time period, a ranking for each content item scheduled in each timeslot; selecting, for each timeslot, a content item based on the ranking; and creating one or more virtual channel schedules comprising at least the identifier for the selected content items from the two or more existing channels.

### FIELD OF THE INVENTION

The present disclosure relates to a system and method for creating a virtual channel. In some examples, the virtual channel can be configured for specific users or user groups.

### BACKGROUND OF THE INVENTION

Developments in technology, for example, the advent of digital television, internet enabled video-on-demand services and the availability of personal video recorders has led to consumers altering their viewing habits including how, where and when they consume video and other content. Furthermore, the amount of content that is available via many systems has expanded enormously.

In this context, during a viewing session, a viewer is faced with a very large choice of what to watch from a wide range of available content sources. Faced with such a large choice a viewer may view or otherwise consume content they are already familiar with rather than try something new.

The large choice of content and the increased variety of content sources has led to various technical developments to enable users to better access and select content, for example developments to electronic program guides (EPGs). It is also known for viewers to filter the large choice of content using a search function. However, both approaches can result in viewers continuing to view content with which they are already familiar. Ultimately, this can lead viewers to become dissatisfied as they may feel they are not exploiting the system and range of content to the full. It can be frustrating and time consuming for a user to seek out suitable new content available from the wide range of choices available from TV and other content service providers. It has been suggested to provide viewers with content recommendations, which may lead them more rapidly to content that may be of interest. However, traditional content recommendation systems only work with video-on-demand systems.

For linear broadcast content providers, content is streamed ‘live’ to multiple users according to a broadcasting schedule. At present, there is no mechanism to personalise such linear channels.

### SUMMARY OF THE INVENTION

In a first aspect of the disclosure, there is provided a computer-implemented method for creating a virtual channel based on linear broadcast content, the method comprising:
obtaining scheduling information and content information associated with a plurality of content items in a content schedule for two or more existing channels, the content information comprising at least an identifier for each content item;
determining, for each timeslot in a predetermined time period, a ranking for each content item scheduled in each timeslot;
selecting, for each timeslot, a content item based on the ranking; and
creating one or more virtual channel schedules comprising at least the identifier for the selected content items from the two or more existing channels.

Embodiments of the disclosure therefore provide a method which can be used to create a virtual channel of live streamed content wherein the content in the virtual channel has been selected from amongst content that is being streamed for two or more existing channels. As such, a user can be presented with scheduled content from across a number of channels without having to scroll through multiple channels and channel-hop in order to watch the content they are most likely to enjoy. In other words, the system running the method can effectively recommend live streamed content that is broadcast on different channels to be viewed continuously via the virtual channel.

The ranking for each content item may be based on one or more of: a popularity of the content items; a language of the content items; a type of the content items; metadata associated with the content items; a rule associated with the content items; or user activity associated with at least one user.

The linear broadcast content may be provided by a Free Ad-supported Streaming Television (FAST) channel provider.

The user activity may comprise interactions by the at least one user in relation to a plurality of content items. The method may further comprise monitoring user activity including identifying content that a user of a user device has interacted with and adding content item identifiers, for the identified content, to user data.

The user activity may be associated with a plurality of content items interacted with by a single user or a single subscriber.

The user activity may be associated with a plurality of content items interacted with by a plurality of users.

The ranking for each content item may be based on recommendation data derived from monitoring user activity. The recommendation data may be determined by identifying collaborative content comprising content viewed by other users.

The method may further comprise providing the one or more virtual channel schedules for display, for example, on an electronic program guide.

The scheduled content items in the one or more virtual channel schedules may be selectable by a user such that the user may delete and/or replace a selected item.

The selected item may be replaced by another content item scheduled to be broadcast on an existing channel in the same timeslot.

The selected item may be replaced by on demand content.

The method may comprise:
obtaining user-derived metadata representing at least some properties associated with the plurality of content items interacted with by the at least one user;
obtaining content-derived metadata representing at least some properties associated with the plurality of content items in the content schedule; and
comparing the user-derived metadata with the content-derived metadata to determine the ranking for each content item.

The method may further comprise determining a first weighting for the user-derived metadata and obtaining a second weighting for the content-derived metadata and comparing the second weighting with the first weighting to determine the ranking for each content item. The weighting may relate to an importance of each piece of metadata in relation to the content.

The ranking may be based on how close the content-derived metadata for the scheduled content items matches the user-derived metadata. The ranking may comprise ordering the scheduled content items from most closely matching to least closely matching.

The plurality of content items interacted with by the at least one user may comprise content items having been one or more of: selected, viewed, recorded, purchased, read, listened to, played, shared, content rated, commented on, downloaded, watched, bookmarked, browsed, added to a shopping basket, watched or listened to a trailer, clicked on a search result, remotely recorded, set a reminder for, liked, disliked, tweeted, posted on social media, played purchased content, stopped watching, stopped playing or otherwise interacted with.

The content-derived metadata and/or the user-derived metadata may comprise data relating to one or more of: actor; audience; award; category; character; character type; concept source; director; format; franchise; host; milieu; mood; producer; person; singer; subcategory; scenario; setting; sports competition; studio; style; subject; team; theme; time period; and writer.

The content items may comprise one or more of: television content; video content, audio content, visual content, computer games, printed content, text-based content, live performances, movies, TV programs, music, podcasts, talking books, computer games, books, magazines, news, recipes, concerts, plays, comedy performances, entertainment or sporting events.

The method may further comprise storing the user activity and/or the interacted content items and/or metadata associated with the interacted content items in user profiles in a first memory resource remote from user devices.

The method may comprise storing the scheduled content items and/or metadata associated with the scheduled content items in one or more content memory resource.

The method may comprise determining a personalised ranking for multiple users at substantially a same time; selecting, for each timeslot and each of the multiple users, a content item based on the ranking; and creating one or more virtual channel schedules for each of the multiple users, said virtual channel schedules comprising at least the identifier for the selected content items. In some cases, the multiple users may comprise thousands, tens of thousands, hundreds of thousands or millions of users and the method may comprise creating personalised virtual channel schedules for each user at substantially the same time.

In a second aspect of the disclosure, there is provided a system for creating a virtual channel based on linear broadcast content, the system comprising processing circuitry configured to:
obtain scheduling information and content information associated with a plurality of content items in a content schedule for two or more existing channels, the content information comprising at least an identifier for each content item;
determine, for each timeslot in a predetermined time period, a ranking for each content item scheduled in each timeslot;
select, for each timeslot, a content item based on the ranking; and
create one or more virtual channel schedules comprising at least the identifier for the selected content items from the two or more existing channels.

In a third aspect of the disclosure, there is provided a non-transitory computer-readable medium that comprises computer-readable instructions that are executable to perform a method for creating a virtual channel based on linear broadcast content, the method comprising:
obtaining scheduling information and content information associated with a plurality of content items in a content schedule for two or more existing channels, the content information comprising at least an identifier for each content item;
determining, for each timeslot in a predetermined time period, a ranking for each content item scheduled in each timeslot;
selecting, for each timeslot, a content item based on the ranking; and
creating one or more virtual channel schedules comprising at least the identifier for the selected content items from the two or more existing channels.

The content may be provided by a content distribution system (or content provider system) and may comprise at least one of a TV distribution system, a TV subscription service, a video-streaming system.

The content distribution system has a plurality of users and may comprise at least 10,000 user devices, optionally at least 100,000 user devices, optionally at least 1,000,000 user devices.

The content may be configured for a user device such as a set top box, a television, a mobile device, a smartphone, a computer, a tablet, a game console or other device.

Reference to a user may include reference to a subscriber. A subscriber may have a plurality of users associated with it. For example, a subscription may be associated with a household and there may be a plurality of users, for example family members, associated with the subscription and who may, for example, interact with content.

The method may further comprise storing the virtual channel schedule in a database and/or outputting the virtual channel schedule via a batch process.

The method may comprise opening a virtual channel creation session prior to obtaining scheduling information and content information associated with a plurality of content items in a content schedule for two or more existing channels.

The method may comprise retrieving user data for a plurality of users from a first storage resource, storing the user data in a second storage resource, and maintaining the user data in the first and/or second storage resource during the virtual channel creation session.

The method may comprise using the user data from the second storage resource and content information from one or more content sources to generate at least one virtual channel schedule during the virtual channel creation session.

The providing of the at least one virtual channel schedule may comprise providing the at least one virtual channel schedule to an operator device of the content distribution system or to the user device, either directly or indirectly. The at least one virtual channel schedule may be provided to a further device, database and/or system that may process and/or send the at least one virtual channel schedule to the user device.

The first storage resource may comprise at least one of a remote storage resource and a less rapidly readable storage resource, and/or the second storage resource may comprise at least one of a local storage resource and a more rapidly readable storage resource.

The first storage resource may comprise a hard disk storage resource and the second storage resource may comprise random access memory (RAM).

The user data, for each user, may be stored in the first storage resource at substantially contiguous physical storage locations.

Storing the user data, for each user, at substantially contiguous physical locations may comprise storing the user data in a single sector of the first storage resource, or in a plurality of substantially contiguous sectors of the first storage resource.

The user data may be updated in one or more of the first storage resource and the second storage resource during the virtual channel creation session. For example, the user data in the second storage resource may represent a snapshot of the user data in the first storage resource at a beginning of the virtual channel creation session.

In some cases, the user data may be maintained in parallel in both the first and second storage resources, for example both in a hard disk resource in RAM.

The updating of the user data in the second storage resource may be performed in response to each new relevant user action, and the updating of the user data in the first storage resource may be performed at least one of:
a) in response to an expiry of the virtual channel creation session;
b) periodically;
c) in response to at least one of processing capacity or communication capacity being available.

The updating of the user data in the first storage resource may comprise copying of at least some of the data from the second storage resource to the first storage resource.

The updating of the user data in the first storage resource and the updating of the user data in the second storage resource may be both performed in response to each new relevant user action.

The updating of the user data for each user in the first storage resource may comprise storing the updated user data for the each user at substantially contiguous physical locations at the first storage resource.

The updated user data for each user may comprise new user data and pre-existing user data, and the storing of the updated user data for each user may comprise storing the new user data in the first storage resource at physical locations substantially contiguous with physical locations at which the pre-existing user data for each user is stored.

The pre-existing user data for each user may comprise user data for each user that was already stored in the first storage resource at the start of the virtual channel creation session.

The method may comprise deleting the user data for each user from the second storage resource in response to at least one of: expiry of the virtual channel creation session; the second storage resource being full or exceeding a threshold storage limit.

The user data may comprise user preference data based at least in part on user activity and, optionally, on at least one user preference selection by the user.

The user data may comprise at least one of: user action data representing previous user actions, optionally content selection, viewing or recording actions, user language data and/or episode data; content metadata representing properties of content viewed, recorded or selected by a user.

Features in one aspect may be provided as features in another aspect. For example, method features may be provided as apparatus features and vice versa.

### BRIEF DESCRIPTION OF THE DRAWINGS

Various aspects of the invention will now be described by way of example only, and with reference to the accompanying drawings, of which:

FIG. 1 is a schematic diagram of a system for creating a virtual channel, for example, for an electronic program guide;

FIG. 2 is a representation of certain database learning tables used by the system of FIG. 1;

FIG. 3 is a simplified schematic of the system of FIG. 1;

FIG. 4 is a simplified schematic of an alternative system arrangement to that of FIG. 3;

FIG. 5 is a schematic of a system for creating a virtual channel;

FIG. 6 is a schematic illustration of the generation of user records using the system of FIG. 1; and

FIG. 7 is an overview of a method for creating a virtual channel in accordance with an embodiment.

### DETAILED DESCRIPTION

In TV systems, or other systems for provision of content to a user, each service provider may have thousands, tens or hundreds of thousands, or millions of customers, wherein each customer is unique and may have different viewing habits and preferences. It has therefore been recognized that each customer, or at least different groups of customers, may require different content.

Tracking, recording and processing large volumes of customer data and large amounts of content data in order to determine what content may be popular, taking into account the time constraints demanded by a viewer and by the system poses a significant technical challenge. The time constraints demanded by particular content providers, or expected by users, for provision of content may be particularly demanding, with, for example, content recommendations being required to be generated almost instantaneously, for example within a few hundred milliseconds of a user switching on a set top box or otherwise beginning a viewing session. This can present a significant technical challenge, particularly as the virtual channel creation system may be hosted on a server remote from the set top box and, for systems with millions of subscribers, may have to deal simultaneously with hundreds of thousands of user actions and requests for virtual channels per minute during busy periods.

An ability to maintain anonymity of the users (e.g. to avoid issues in connection with the General Data Protection Regulation (GDPR) or similar) when providing recommendations in the form of virtual channel schedules and taking other actions, may be important in some embodiments. The content provider system and/or the virtual channel creation system described herein may be configured so as to restrict or not allow access to personal information, or data that could be used to determine the name of a user, or demographic information concerning the user.

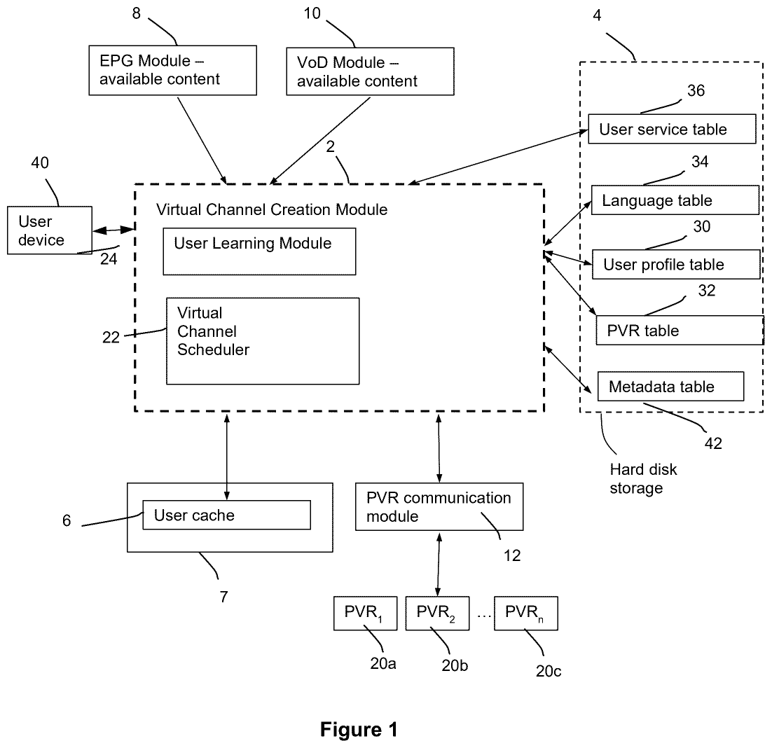

The system of FIG. 1 is able to provide virtual channel schedules in real time or near real time for many thousands, tens of thousands or even hundreds of thousands or more users, for example using techniques as described in UK Patent No. GB 2574581 or U.S. Pat. No. 11,343,573, the content of each of which is incorporated herein by reference.

FIG. 1 shows a schematic diagram of a virtual channel creation system according to an embodiment. The system is able to provide a virtual channel schedule, recommending live streamed content, in a timely manner, based on real time or near real time monitoring of user actions for many thousands, tens of thousands or even hundreds of thousands or more users.

Example modes of operation are described below but recommended content for the virtual channel schedule may be determined for any suitable users or user accounts, with the virtual channel schedule being accessible via any suitable devices, for example set-top boxes, smartphones, personal computers (PCs) or tablets or any other suitable content delivery mechanism.

The system comprises a virtual channel creation module 2 linked to a first storage resource in the form of a hard disk storage device 4, which is used to store various user data. The virtual channel creation module 2 is also communicatively linked to a second storage resource in the form of a local storage device that includes at least one cache, for example a user cache 6. In the embodiment of FIG. 1 the local storage device is in the form of RAM 7 but any suitable storage device may be used in alternative embodiments. The user cache 6 may be used for temporary storage of user data obtained from the hard disk storage device 4 during a virtual channel creation session, as discussed in more detail below.

In the embodiment of FIG. 1, the virtual channel creation module 2 comprises a user learning module 24 and a virtual channel scheduler 22.

The user learning module 24 is configured to monitor user activity including identifying content that the user of a user device 40 has interacted with, for each of a plurality of user devices 40. Optionally, the user learning module 24 may obtain metadata concerning the identified items of content, the metadata representing at least some properties of the identified items of content.

The virtual channel scheduler 22 is configured for obtaining scheduling information and content information associated with a plurality of content items in a content schedule for two or more existing channels, the content information comprising at least an identifier for each content item; determining, for each timeslot in a predetermined time period, a ranking for each content item scheduled in each timeslot; selecting, for each timeslot, a content item based on the ranking; and creating one or more virtual channel schedules comprising at least the identifier for the selected content items from the two or more existing channels.

As discussed further below, the virtual channel creation module 2 is able to communicate, either directly or indirectly, and either via wired or wireless connection, with very large numbers of users via user devices 40 and to provide virtual channel schedules for such users via the user devices 40. Other than some personal video recorders (PVRs) which are shown schematically in FIG. 1, multiple user devices 40 are not shown in FIG. 1 for clarity. However, it will be understood that although a number n of PVRs (20a, 20b, 20c) are shown communicatively connected to the virtual channel creation module 2 via a PVR communication module 12, the PVRs may constitute or be comprised within user devices 40.

The virtual channel creation module 2 is also linked to sources of information concerning available content, in this case an EPG module 8 and, optionally, also a Video-on-Demand (VOD) module 10, which, respectively, provide information concerning content available to a user via an EPG (for example, scheduled TV programs on a set of channels) and via a VOD service. In alternative embodiments, a variety of other sources of content may be available as well as, or in addition to, EPG and VoD content, for example internet content and/or any suitable streamed content via wired or wireless connection.

In the embodiment of FIG. 1, the EPG module 8, the VOD module 10, the virtual channel creation module 2, the user cache 6, the PVR communication module 12, the virtual channel scheduler 22 and the user learning module 24 are implemented in a server. The server includes communication circuitry that enables communication between the server, or appropriate components of the server with each of the user devices 40, and with the content sources, for example a TV service operator or other content service operator.

Any other suitable implementation of the EPG module 8, the VOD module 10, the virtual channel creation module 2, the user cache 6, the PVR communication module 12, the virtual channel scheduler 22 and the user learning module 24 may be provided in alternative embodiments, for example they may be implemented in any software, hardware or any suitable combination of software and hardware. Furthermore, in alternative embodiments any one of the components as described in relation to the embodiment of FIG. 1 or other embodiments may be combined with any other one(s) of the components, or any one of the components may be split into multiple components providing the same or similar functionality.

The EPG module 8 and the VOD module 10 obtain information concerning available content from the content sources, for example a TV service operator or other content service operator. The content information may comprise metadata of content, for example, television program metadata. The metadata may be representative of a variety of different content parameters or properties, for example but not limited to program title, time, duration, content type, program categorization, actor names, genre, release date, episode number, series number. It is a feature of certain embodiments that the metadata stored at the EPG module 8 and the VOD module 10 may also be enriched with additional metadata, for example by the operator of the virtual channel creation system, such that additional metadata to that provided by the content sources or other external sources may be stored.

In the embodiment of FIG. 1 the virtual channel creation server, in particular the virtual channel creation module 2, communicates directly with each of the user devices 40, for example to monitor user activity, to identify content that the user of a user device 40 has interacted with, and to store user data relating to the identified content in the hard disk storage device 4. In some embodiments, the virtual channel creation module 2 communicates with the user devices 40 via the content sources or via other servers or devices. For example, in such other embodiments, user activity data may be sent to the virtual channel creation server via one of the content source servers or other server or device.

In the embodiment of FIG. 1 the system operates to create a virtual channel using the EPG module 8 to provide real-time linear content information, for example relating to terrestrial or satellite broadcast television for two or more existing channels. In addition, in some embodiments, content scheduled in a virtual channel may be substituted, for example, by a user, by one or more video-on-demand (VOD) services, or pre-recorded video content stored on one or more personal video recorders (PVR). In other embodiments further sources of content as well as or instead of the above may be used. The available content sources may be provided to the user devices 40 from a content provider.

The operation of the virtual channel creation system is controlled by the virtual channel creation module 2. As can be seen in FIG. 1, the virtual channel creation module 2 is configured to communicate with the one or more content information modules: in this case, the electronic program guide (EPG) module 8 and VoD module 10. The virtual channel creation module 2 is also configured to communicate with the user cache 6 local to the virtual channel creation module 2, the hard disk storage resource 4 and the one or more PVRs. A data access layer provides a communication interface between the virtual channel creation module 2 and the hard disk storage resource 4. The personal video recorder (PVR) communication module 12 provides a communication interface between the one or more PVRs 20a, 20b, . . . 20z and the virtual channel creation module 2.

The virtual channel creation module 2 has a virtual channel scheduler 22 and a user learning module 24. The virtual channel scheduler 22 applies a set of processes to determine, in real time, a virtual channel schedule based on at least the scheduled content for two or more linear broadcasting channels.

The user learning module 24 receives data indicative of selections or other actions by a user and builds up a set of user data, for example comprising or representing a user history or profile, which is stored in the hard disk storage 4, and which is used in some embodiments to generate a personalized virtual channel schedule for the user. Operation of the virtual channel scheduler 22 and the user learning module 24 is discussed in more detail below.

In relation to FIG. 1, a request for a virtual channel schedule may be received by the virtual channel creation module 2. A user action carried out on the user device 40 may also be received by the virtual channel creation module 2. In addition to receiving requests for virtual channel creation, the virtual channel creation module 2 is configured to log user activity. By logging user activity and storing activity over an extended period of time, the virtual channel creation module 2 and the hard disk storage 4 can build up an overall picture of the viewing activities, habits and preferences of a plurality of users. User actions are turned into learn actions by the user learning module 24, which may be processed by the virtual channel scheduler 22.

The system of FIG. 1 is configured to operate with a plurality of user devices 40 each associated with at least one user. The plurality of user devices 40 may comprise a large number of devices, for example thousands, tens or hundreds of thousands, or even millions of devices. Each user device 40 may be any device or combination of devices that is configured to enable a user to view or otherwise consume content. For example, each user device 40 may comprise an internet-enabled device and/or a device for providing video or other content on demand but at least it is a device capable of receiving a real-time linear television broadcast signal. The user device 40 may be a mobile device, for example a tablet, a smart phone or a laptop. Alternatively, the user device 40 may not be mobile, for example, an internet browser enabled computing device, a smart television or a set-top box. The user device 40 may also have an in-built or associated PVR for recording and storing content in some embodiments.

The user may be a viewer of the user device 40. Alternatively or additionally, the user may be a subscriber and/or customer of a service accessible through the user device 40.

The user device 40 is communicatively coupled to the virtual channel creation module 2. The virtual channel creation module 2 has an application programming interface (the recommendation engine API) that provides a set of rules for monitoring user activity and carrying out a virtual channel creation procedure.

The user cache 6 is coupled to the virtual channel creation module 2 and is configured to store data that be used for the virtual channel creation procedure. The virtual channel creation module 2 can access data stored on the user cache 6. The user cache 6 may be provided in random access memory (RAM) 7.

The hard disk storage 4 is communicatively coupled to the virtual channel creation module 2. The hard disk storage 4 stores data which may be used by the virtual channel creation module 2. The hard disk storage 4 is configured to store one or more databases. Entries from the databases on the hard disk storage resource 4 may be retrieved by the virtual channel creation module 2 via requests made through the data access layer. Entries in the databases may also be updated via the data access layer.

The database(s) at the hard disk storage 4 store user data that may be used by the virtual channel creation module 2 to determine a virtual channel schedule. In the embodiment of FIG. 1 a set of database tables is provided that store information concerning the users.

In the embodiment of FIG. 1, the tables may include at least one user service table 36 that represents user service requirements, and at least one user profile table 30 that includes user attribute data that may be considered to represent a user profile. A user profile may include, for example, the following attributes: unique identifiers, for example a user identifier, a subscriber identifier, an anonymous session identifier; one or more unique geographic identifiers; a flag indicating whether or not the user has a PVR; a flag indicating whether or not the user is in debt; a flag indicating whether or not the user has opted out of receiving marketing material; one or more codes indicating one or more preferred languages of the user; a flag indicating if the user has opted out of receiving personal recommendations; the age of the user; the name of the user and the gender of the user.

In the embodiment of FIG. 1, the tables, for example, the user profile table 30, may include various user learning tables that include data representing for example the viewing activities, habits and preferences of each user. The user data can include data representing for examples explicit ratings given by a user to a particular program or other item of content. It is a feature of the embodiment of FIG. 1 that the user data also includes data representing actions, for instance viewing actions, taken by a user.

For example, if a user selects a program or other item of content and views or otherwise consumes it for greater than a threshold period of time then a learn action is generated and at least one user data item for that user is stored in at least one of the tables. The data item may include various data including for example start and stop viewing time, time slot identifier, program identifier, at least some metadata concerning the program (which may be stored in metadata table 42, although such metadata may be stored separately as content data rather than user data in some embodiments, and linked to or otherwise accessed if required, for example by the program name or other identifier). The user learning module 24 determines whether user data should be stored in the tables in respect of a particular user action or set of actions. For example, if a user only views a program for a very short period of time, for instance if they are channel surfing, then user data is not stored in the user learning tables in respect of that action. User data can be stored in respect of a variety of different user actions or events, for example selecting, viewing, recording or searching for content.

The learned language table 34 stores data relating to audio languages of content items that have been user actioned by the user.

The PVR table 32 stores data associated with content a user has recorded on their PVR.

In the embodiment of FIG. 1 it can be understood that a large part of the user data comprises user history or user action data that represent user actions over a significant period of time. The virtual channel creation module 2 can use such user data during a virtual channel creation procedure to determine which content to include in a virtual channel schedule.

In various embodiments, there is a limit to how long user data is kept or used. For example in the embodiment of FIG. 1 after a threshold period, for example six months or a year after being collected, items of user data may be deleted. Thus, in some embodiments the user data for a particular user may include only relatively recent user action data, although the amount of data may still be substantial.

In the embodiment of a FIG. 1, a distinction is made between different types of user and different sets of the tables may be stored for the different types of users.

It will be understood that requests (e.g. for user data) and results may be communicated between different parts of a network using one or more application program interfaces (APIs). The API defines the parameters and other data to be included in the request and the form and format of the results from the request.

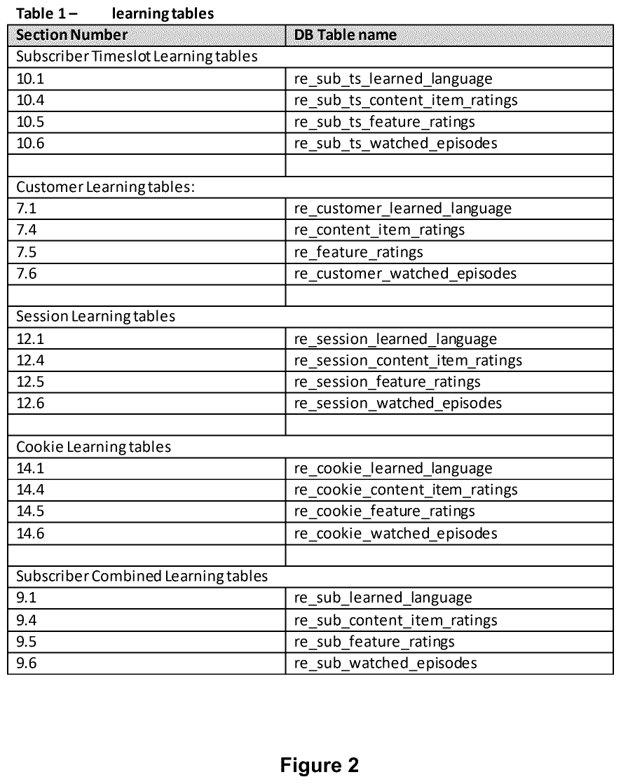

FIG. 2 is a representation of certain database learning tables stored on the hard disk storage resource 4 of the embodiment of FIG. 1. The virtual channel creation module 2 supports different categories of user. The tables of FIG. 2 correspond to different categories of user. The categories in this embodiment are: customer, subscriber and anonymous. Subscriber can, for example, refer to combined subscriber mode or time-slot subscriber mode. Anonymous can, for example, refer to cookie and/or session modes.

A customer may be a user who uses a service or content source. A customer profile may store one or more of the following attributes in some embodiments: preferred features; indication of preferred viewing times e.g. day, start and end times. The customer profile table also stores a list of the favorite content item group information: content source (e.g. EPG or VOD) and unique identifiers for content item groups.

A subscriber may be a person who has subscribed to a particular service rather than the individual user who is using the service. For example, the subscriber can be an account holder or an entity that represents a household. Individual users may be associated with a subscriber. There are at least two modes of operation of subscriber profiles. The first is combined mode, where data for the subscriber (for example attributes and/or subscriber actions) is stored. In that case, metadata and content recommendations, for example, may be based on attributes and/or user actions for a plurality of users associated with the same subscription, for example different members of the same household. The second is time-slot mode where content recommendations may be generated in dependence on the particular time slot in question. For example user data generated for a particular time slot may be used selectively in generating metadata for a particular time slot (potentially with user data generated for other times slots being ignored or weighted to be of less significance) and/or with different rules and/or attributes being used for different time slots. For instance, there may be a rule that no adult content be recommended for morning or afternoon time slots, only for late evening or night-time time slots. Similarly, greater weighting may be given to children's programs for certain time slots, for instance late afternoon time slots, making actions associated with children's programs more likely during those time slots.

Anonymous profiles may be used to recommend content, for example, when neither the individual customer nor subscriber to a service is known. For example, for a web user who has not logged in is an anonymous user. There are two modes of operation of anonymous profiles. These are session mode (either single-session or multi-session mode) and cookie mode.

In single-session mode preferences of the anonymous consumer are stored in memory for the duration of a single session and then removed from memory at the end. In multi-session mode preferences of the anonymous consumer are kept in memory over more than one session. The anonymous profile is identified over more than one session using a unique session id stored in the anonymous profile.

In cookie mode, anonymous session tracking can be performed using cookies, wherein on a first request a cookie containing a unique identification is added and in later sessions used to identify the anonymous user. This works in a web environment. A cookie session profile holds a list of cookies that are known to the system together with data referring to when the cookie was created or last accessed by the system.

For each user of all categories, the system has separate groups of learning tables. In FIG. 2, the learning tables shown include “learned language”, “content item ratings”, “feature ratings” and “watched episodes”. These tables are shown by way of example and other tables may be created such as “exclude content group.” Other tables may also be stored in the embodiment of FIG. 1. Each user may have explicit preferences and implicit preferences. Explicit preferences are information the consumer tells the system by, for example, entering a questionnaire. Implicit preferences are information learned by the system through user actions. Data corresponding to user actions for the purpose of learning are stored in the learning tables.

The learned language table 34 stores data relating to audio languages of content items that have been user actioned by the user. For example, the table can store learned language information, the date at which the language was learned and an indication of whether or not the entry has been aged out.

The content item ratings table stores data representing properties of content such as the features, actors, channels. Feature ratings allows learn actions to specify properties of content information instead of the content item. A customer is capable of applying ratings to a content item. Rating information is stored in the customer feedback table (e.g. user profile table 30) and includes: time and date rating given; customer identifier; activity identifier; name and identifier of content item rated; content item group identifier if content item associated with a content item group; rating value; a scaled rating value to be used by the virtual channel creation module 2; feature ratings; content source ID; client type ID; series title of content item and content item instance identifier. A flag is also stored to indicate if a recommendation has aged out or not. A feature rating made by a customer can also be stored on a specific list of features and/or sub-genres.

The watched episodes table stores data corresponding to a last actioned episode of a series as actioned by a user. For example, for each customer the episode history for the customer is stored. This includes a series identifier; a series title; a season and episode number, and the date and time the user action occurred.

The exclude content group table may store data corresponding to content explicitly excluded by the user. For example, the feedback tables also contain information on content items and content item groups that have been manually excluded by the customer. For example, for individual content items that have been excluded this information includes: identifier of the content item; content source; data and time of exclusion; series title of content item; client type ID (e.g. web, call center, set-top box). For content item groups, this information includes: customer identifier, time and date content item group excluded; content source; client type ID. In both cases, a flag is included that indicates whether or not the exclusion has been aged out.

In some embodiments, different data tables or combinations of data tables may be stored.

Although a particular system arrangement is shown in FIG. 1, there are various system arrangements that could be used.

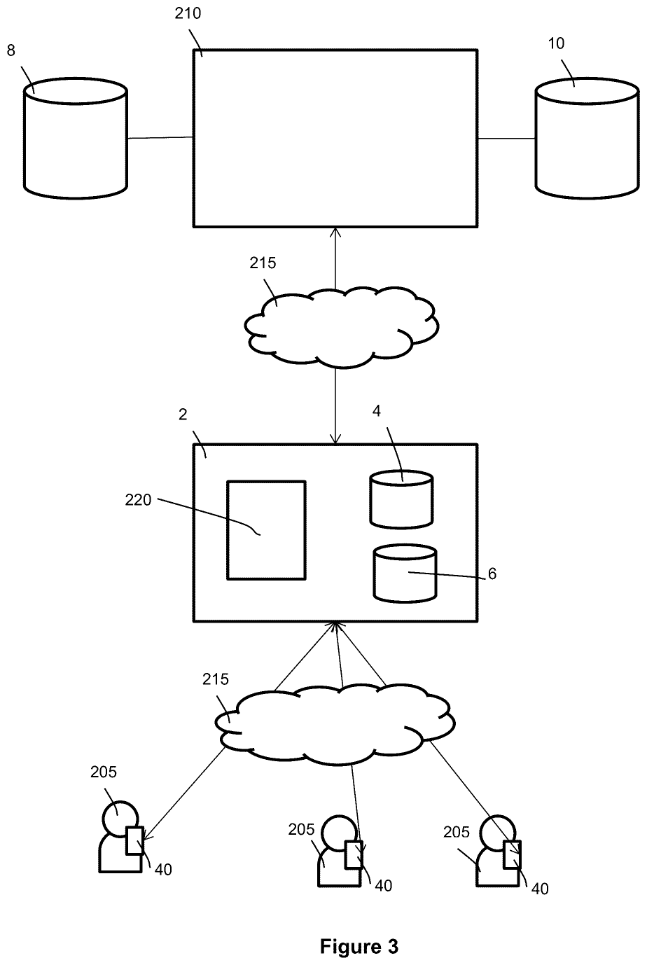

FIG. 3 shows a “middleware” arrangement in which the virtual channel creation module 2 sits as “middleware” between users 205 and systems of a content provider 210. The content provider systems 210 are configured to provide a variety of content, e.g. real-time linear television 8 and, optionally, VOD 10 to a plurality of users 205. The virtual channel creation module 2 is implemented by processing resource 220 (which may comprise one or more processors) with the storage device 4 and user cache 6. In some examples, the virtual channel creation module 2 can be implemented by a cloud computing system, by one or more servers or other suitable enterprise level computing system. In this arrangement, systems that implement the virtual channel creation module 2 receive data sent from the user devices 40 of the users 205 that represents the user actions/user activity taken by the user 205 that are relevant to the virtual channel creation module 2, such as but not limited to actions taken by the user 205 to view or select content, including one or more of the user actions listed herein. The user devices 40 also provide a user ID that can be used to identify the user 205 to allow the provision of a virtual channel schedule based on the user actions and preferences of a group of users 205. The user devices 40 communicate the data over a network, such as the cloud 215, to the virtual channel creation module 2. The virtual channel creation module 2 records the user actions in order to generate learn actions and build and update the user profiles that can be used together to make a virtual channel schedule. The virtual channel creation module 2 can communicate requests and other data from the user devices 40 to the content provider systems 210 over a network, such as the cloud 215, in order to provide the content and/or virtual channel schedule to the user devices 40.

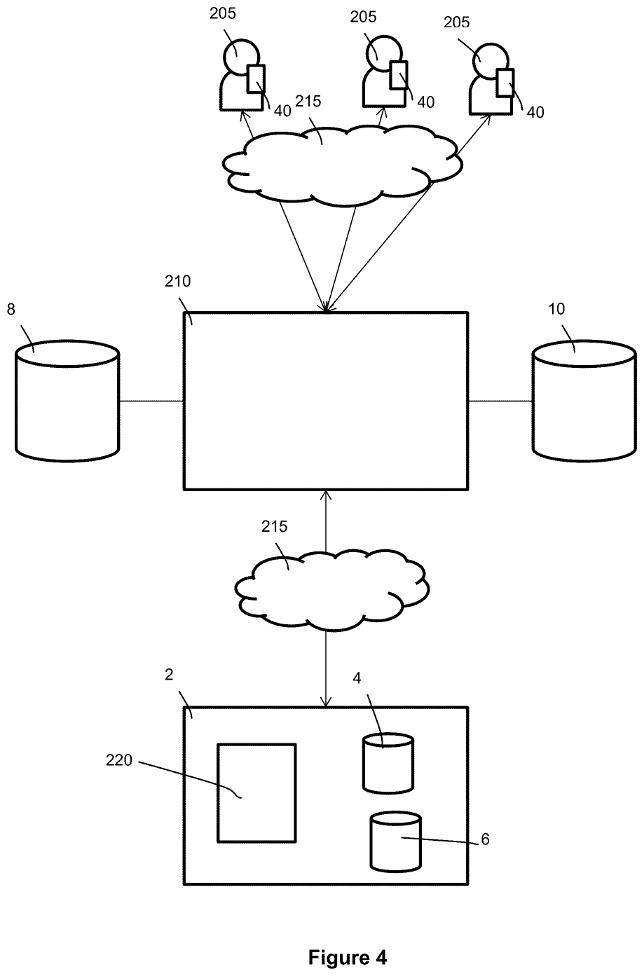

Other system arrangements that provide similar functionality to determine one or more virtual channel schedules for a group of users are possible. FIG. 4 shows another system configuration in a “backend” processing arrangement. In this arrangement, the user devices 40 interface directly (over a network such as the cloud 215) with the systems of a content provider 210, which handles requests from and provides content to the user devices 40. User interaction data from the user devices 40 is provided by the systems of the content provider 210 to the virtual channel creation module 2 (e.g. over a network such as the cloud 215) in order for the virtual channel creation module 2 to identify learn actions and build user profiles for a plurality of users 205. The virtual channel creation module 2 gathers the data from the user profiles in order to determine a virtual channel schedule for the user group.

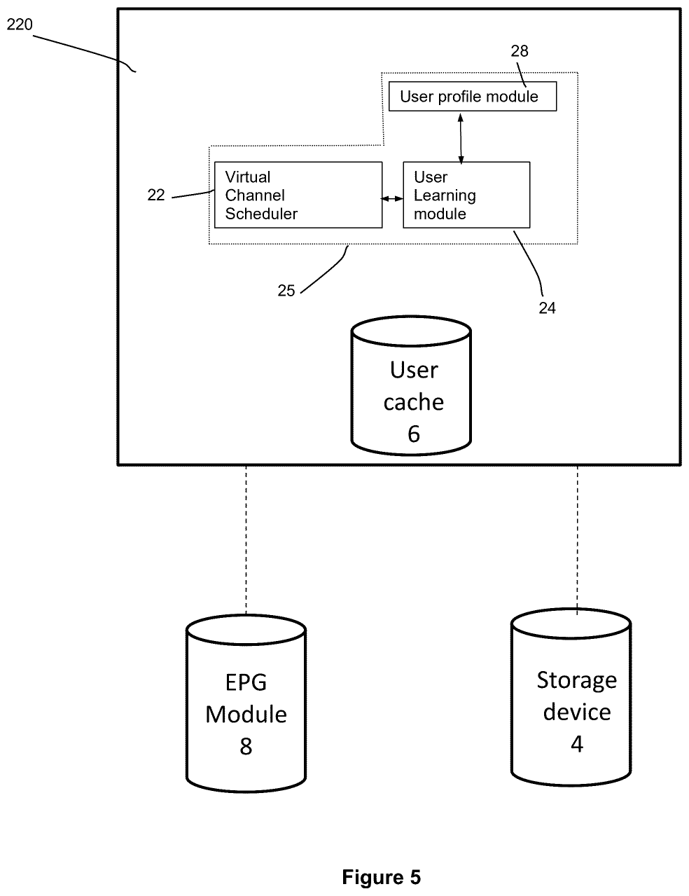

FIG. 5 shows an arrangement of processing resource 220 for implementing the virtual channel creation module 2, including the user learning module 24 and the virtual channel scheduler 22. In this embodiment, the user learning module 24 is part of a virtual channel system 25, which includes the virtual channel scheduler 22 and a user profile module 28. However, in other embodiments, the user learning module 24 may be separated from the virtual channel system 25. The processing resource 220 can optionally comprise one or more processors, FPGAs, ASICS or the like, which may be provided in a single machine or distributed over a plurality of machines, and may be locally arranged or remote from each other and connected over a network. The processing resource 220 is configured to communicate with content databases, such as the EPG module 8, to retrieve content available for selecting for a virtual channel schedule. The processing resource 220 comprises rapid access storage, such as user cache 6, which may be implemented in RAM or SSD storage to provide fast access to user profiles and actions that the processing resource 220 is currently, and will next be, performing operations on. The processing resource 220 is also configured to communicate with external storage such as the storage device 4 on which user actions and profiles are stored and can be retrieved into the user cache 6 when needed by the processing resource 220. The virtual channel scheduler 22 can be accessed by the operatives of the virtual channel creation system, which may include operators of the content provider systems 210 (or other suitable users) to provide a virtual channel schedule to users. As part of this, the virtual channel scheduler 22 can obtain scheduling information and content information associated with a plurality of content items in a content schedule for two or more existing channels, the content information comprising at least an identifier for each content item; determine, for each timeslot in a predetermined time period, a ranking for each content item scheduled in each timeslot; select, for each timeslot, a content item based on the ranking; and create one or more virtual channel schedules comprising at least the identifier for the selected content items from the two or more existing channels.

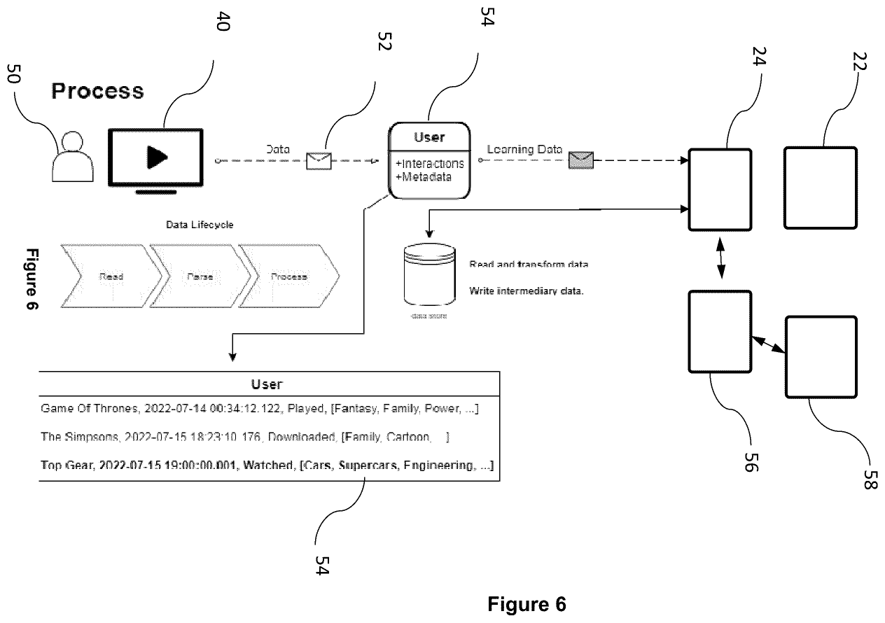

The above description has been provided concerning the structure of the system of FIG. 1. Operation of the system of FIG. 1 to provide a virtual channel schedule according to one mode of operation is now described with reference to the flowchart of FIG. 6.

FIG. 6 illustrates schematically a process for generation of a virtual channel schedule using the system of FIG. 1. Only certain components of the system of FIG. 1 are included in FIG. 6, for clarity.

FIG. 6 shows a user 50 watching a television program that they have selected on user device 40. Data 52 representing the user's activity is sent to the user learning module 24 and a learn action, as mentioned above, is performed that results in at least one user data item for that user being added to at least one of the tables. The user data item may comprise data concerning the item of content and data concerning the viewing, for example start and stop times for the viewing.

The collection of data items stored in the tables concerning the user, for instance, viewing of content by the user may be referred to as a user record or user profile for the user.

A user record 54 for the user is illustrated schematically in FIG. 6. An expanded version of at least part of the user record is also shown in FIG. 6 for purposes of illustration. In this example, the user has performed actions in relation to three items of content. In particular, the user has played an episode of Game of Thrones on 14 Jul. 2022, has downloaded an episode of The Simpsons on 15 Jul. 2022, and has just watched an episode of Top Gear on 15 Jul. 2022. Some of the metadata associated with each item of content in the record is shown in FIG. 6. For example, at least the metadata items cars, supercars and engineering are associated with the Top Gear episode. In practice there will be many more items of metadata associated with each item of content.

In general, a user record 54 will include records of far larger numbers of items of content than shown for the purposes of illustration in FIG. 6. However, such a small number of items content might be found for a new user or for a temporary user of a system. For example in some embodiments, the system may be used for a user who is a guest in a hotel or traveler in a vehicle or transport system, and it is a feature of some embodiments that user profiles can be generated even for such temporary or short-term users.

Next, user data in respect of the user 50 is sent to the user learning module 24 in order to generate or update a user profile for the user 50.

In some modes of operation, the entire user record is sent to the user learning module 24 each time the user profile for the user is to be updated, and the user profile is regenerated based on the entire user record. In other modes of operation, only changes to the user record are sent to the user learning module 24, and then the user profile for the user is retrieved and updated based only on the changes to the user record (for example based on the user having watched one or more new items of content).

In the example shown in FIG. 6, for simplicity for the purposes of illustration, the user record sent to the user learning module 24 consists only of the record for the latest item of content viewed, in this case TOP GEAR.

In this example, the user record includes the metadata items ‘cars,’ ‘supercars,’ ‘engineering’ and ‘talk-show.’

The user learning module 24 in this embodiment then performs a search of various data sources 56, for example in the cloud, to determine any other information concerning the item of content. For example, various databases can be consulted that include additional information concerning television programs or other items of content.

In the present embodiment, the record for the item of content and any other information found from the search of data sources 56 is subject to processing by sub-module 58 that matches the metadata and other information for the item of content to an ontology of metadata terms that are maintained by the system. Thus, the metadata for the item of content can be enriched, corrected or supplemented.

In some embodiments, the metadata includes features or properties of the item of content and a weighting for the importance of the feature in the item of content. For example, the metadata may comprise the name of an actor in the item of content and the weighting may represent the importance of the actor in the item of content—for example a high weighting would be given to a lead actor while a low weighting would be given to an actor playing a minor role. In another example, the metadata may comprise a mood (e.g. happy, sad, dark, spooky) associated with the item of content and the weighting may represent the dominance of the mood in the item of content.

In the present embodiment the ontology consists of around 38,000 terms that can be used as metadata to represent items of content, for deep content understanding. Any other suitable ontology can be used in other embodiments. In some embodiments, no ontology is used and the raw metadata associated with the item of content (for example, provided by the content maker, distributor or broadcaster) is used without amendment or enrichment.

The metadata (and optionally its weighting) for the item of content is stored in the user record in the hard disk storage 4.

When a virtual channel scheduling session is required, for example, when a request to provide a virtual channel schedule is received by the virtual channel creation module 2 from an operator device (e.g. an EPG provider on initialization of a user session), the virtual channel scheduler 22 retrieves as inputs, for example, via the user cache 6, the user profile (or at least some of the information in the user profile) from the storage device 4 and the metadata associated with available content from, for example, the EPG module 8.

The virtual channel scheduler 22 then uses these inputs to obtain scheduling information and content information associated with a plurality of content items in a content schedule for two or more existing channels, the content information comprising at least an identifier for each content item; determine, for each timeslot in a predetermined time period, a ranking for each content item scheduled in each timeslot; select, for each timeslot, a content item based on the ranking; and create one or more virtual channel schedules comprising at least the identifier for the selected content items from the two or more existing channels. These steps may be performed in a number of ways.

In general, the method may comprise ranking the content items based on a popularity of the content items; a language of the content items; a type of the content items; metadata associated with the content items; a rule associated with the content items; or user activity associated with at least one user.

The virtual channel scheduler 22 may be comprised of one or more components, functional elements or procedures to carry out the above steps. In a non-limiting example, the virtual channel scheduler 22 may comprise a trained machine learning model, which is trained to take as inputs the weighting of the metadata for the content items scheduled in the same timeslot, along with the weighting of the metadata associated with one or more user profiles and to generate a ranking of the best matching scheduled content items based on the weighting of the metadata. The best matching scheduled content items may comprise a single top ranked item of content or, for example, a list of the top two or three ranked scheduled content items, although this may depend on the number of existing channel schedules being considered and the number of virtual channels being created. This initial output may be relayed to another component, functional element or procedure for selecting the content items for the one or more virtual channel schedules, based on the user profile.

In some embodiments, the ranking may be based on popularity (e.g. among a user group) and/or language instead of, or in addition to (e.g. a refinement of), a ranking based on one more or user profiles. This may ensure that any very close matches that are obscure (i.e. very old content) are filtered out and only non-obscure results, in a preferred language, are selected for inclusion in a virtual channel schedule.

In some, but not all, embodiments, a trained machine learning model or other model may be used. For example, a clustering model may be used which may comprise a Kohonen neural network or KMeans clustering technique to cluster the scheduled content into distinct groups, which are unknown to begin with.

In some embodiments, the trained model or other process is applied directly to the metadata without also enriching or mapping to or otherwise using the ontology. In some embodiments more than one trained model is used, for example one or more trained models to enrich or modify metadata associated with the scheduled content items based on the ontology or other further data set, and one or more models to determine the ranking based on user profiles.

In some embodiments, the model may assign scores to each of the items of scheduled content based on how closely the content metadata matches that of one or more user profiles.

This approach may allow for a more accurate and effective technique for selecting scheduled content items for one or virtual channel schedules. As such, users may be presented with virtual channel schedules including content that they are likely to enjoy.

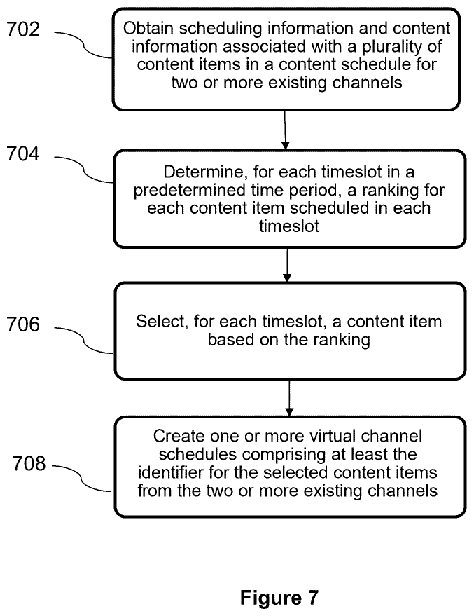

FIG. 7 is an overview of a computer-implemented method for creating a virtual channel, based on linear broadcast content, in accordance with an embodiment.

In general, the method comprises, obtaining scheduling information and content information associated with a plurality of content items in a content schedule for two or more existing channels in a step 702, the content information comprising at least an identifier for each content item. Determining, for each timeslot in a predetermined time period, a ranking for each content item scheduled in each timeslot in a step 704. Selecting, for each timeslot, a content item based on the ranking in a step 706 and creating one or more virtual channel schedules comprising at least the identifier for the selected content items from the two or more existing channels in a step 708.

The method may be stored on a non-transitory computer-readable medium as computer-readable instructions that a processing circuitry, for example, in the virtual channel scheduler 22, can execute.

The live nature of linear broadcast content means that user personalization options are limited. Content, such as TV programs, are broadcast at a set day and time to multiple receivers in a live data stream. Unless the content is recorded locally, users can only watch the content at the time it is aired. This type of system employs multicasting in which content is sent once to multiple users at the same time (i.e. it is a one-to-many distribution system). This contrasts with unicasting systems whereby content may be provided on a one-to-one basis such that individuals can receive the content they want when they want it. However, unicasting systems require a huge amount of bandwidth for streaming content directly to many thousands or millions of users potentially at the same time. Multicasting systems are more efficient in that the same content is broadcast to multiple users at once. However, as users are often presented with many different sources of content and potentially many different live streamed channels there can be a tendency for users to stick to the channels or content that they know they like and, as a result, they may miss out on other content that they may enjoy because it is not a channel they usually watch, for example.

An aim of the present invention is to economically provide live streamed content to users in an easily accessible way. This may be achieved without changing a schedule for live-streamed content and whilst still broadcasting the content once to multiple users. The solution is to create a virtual channel schedule including selected content from across a number of live-streamed channels so as to present content most likely to be of interest to a user, via a single virtual channel. In this way, no alteration is required to the scheduling or broadcasting of programs although it appears to the user that programs from different channels are being provided via a single channel.

In practice, when a user begins a viewing session on a user device 40, a server providing the content (e.g. by way of an electronic program guide) to the user device 40, may send a request for a virtual channel schedule to the virtual channel creation module 2, which may be hosted on a separate server. The virtual channel creation module 2 may obtain scheduling information and content information associated with a plurality of content items in a content schedule for two or more existing channels as part of the request for a virtual channel schedule. Additionally or alternatively, the virtual channel creation module 2 may request the (or more) scheduling information and the (or more) content information from another server (e.g. a server operated by the broadcasting provider or a server providing content metadata).

The scheduling information may comprise start information (e.g. a day and a time) and end information (e.g. a day and time or duration) for the streaming of the content on each existing channel.

The content information will comprise at least an identifier for each content item. The content information may also comprise one or more of: a title, a channel on which it is due to be broadcast, a language, an age rating, a rule regarding when the content can be broadcast and any other metadata. The metadata may comprise data relating to one or more of: actor; audience; award; category; character; character type; concept source; director; format; franchise; host; milieu; mood; producer; person; singer; subcategory; scenario; setting; sports competition; studio; style; subject; team; theme; time period; and writer.

The scheduling information and the content information may be obtained for a pre-determined time period. For example, the pre-determined time period may be for the next 24 hours, the next 48 hours, the next 3 days, the next 5 days or the next 7 days.

The scheduling information and the content information may be stored in a local memory or cache for processing by the virtual channel scheduler 22.

For each timeslot in the predetermined time period, the virtual channel scheduler 22 will rank the content items that are scheduled to be broadcast across two or more existing channels. The timeslot may depend on the content and/or channel information. For example, for a channel comprising content for adults, the timeslot may be 30 minutes or 1 hour as most adult TV programs are of these durations. However, for a channel comprising content for children, the timeslot may be 5 minutes or 10 minutes as many children TV programs are of these durations. The timeslot may be predetermined or based on a minimum duration of all content due to be broadcast at a particular time in the schedule.

In some embodiments, the ranking for each content item may be based a popularity of the content items. For example, popularity data may be obtained for a group of users (or all users), based on prior user interactions with the same or similar content (e.g. for a different episode of the same program). The prior user interactions may be monitored using a process as described in relation to FIG. 6. The popularity of each content item may be based on a number of users viewing the content. The popularity data may be stored in a database accessible by the virtual channel scheduler 22 and the ranking may be based on a comparison of the popularity data stored in relation to each content item that is scheduled in the timeslot concerned. The most popular content may be ranked first and subsequently selected for inclusion in the virtual channel schedule. In some embodiments, more than one virtual channel schedule is created and a second or subsequent item of scheduled content may be selected for inclusion in a second or subsequent virtual channel schedule, based on either the same or a different ranking.

The virtual channel scheduler 22 may then move to the next timeslot in the predetermined time period in order to rank the content items that are scheduled to be broadcast in that timeslot, across the two or more existing channels. In practice, the start time for the next timeslot may be determined based on the end time of the selected content in the previous timeslot. In addition, the virtual channel scheduler 22 may only consider content items due to start at the determined start time in the schedules for the existing channels and may exclude content scheduled to be mid-broadcast at the determined start time. This process may be repeated for all timeslots in the predetermined time period to create a complete and continuous virtual channel schedule.

In some embodiments, the ranking for each content item may take into account a language of the content items. For example, Spanish language content may be more highly ranked than English language content when creating a virtual channel schedule for users based in Spain.

In some embodiments, the ranking for each content item may take into account a type of the content items. For example, the type might indicate a TV program, a radio program or a film. In some embodiments, different types of programs may be preferred at different times of day. For example, for an early morning timeslot a radio program may be more highly ranked, for a mid-day timeslot a TV program may be more highly ranked and for an evening timeslot a film may be more highly ranked.

In some embodiments, the ranking for each content item may take into account a rule associated with the content items. For example, the rule may relate to a type of content required to precede or succeed a certain item of content (e.g. a specific combination of programs may be required or prohibited; or items having a maximum or minimum popularity may be required before or after a certain content item).

In some embodiments, the ranking for each content item may take into account user activity associated with at least one user. Thus, knowledge of viewing patterns may be utilised to create a virtual channel schedule designed to minimise viewer drop-off.

For example, user activity may be monitored and used to determine which programs are popular at different times of the day or week. For programs that are repeated at several different times, the virtual channel schedule can select the showing best suited for a particular user or user group.

The user activity may comprise interactions by the at least one user in relation to a plurality of content items. The method may further comprise monitoring user activity including identifying content that a user of a user device has interacted with and adding content item identifiers, for the identified content, to user data.

The plurality of content items interacted with by the at least one user may comprise content items having been one or more of: selected, viewed, recorded, purchased, read, listened to, played, shared, content rated, commented on, downloaded, watched, bookmarked, browsed, added to a shopping basket, watched or listened to a trailer, clicked on a search result, remotely recorded, set a reminder for, liked, disliked, tweeted, posted on social media, played purchased content, stopped watching, stopped playing or otherwise interacted with.

The user activity may be associated with a plurality of content items interacted with by a single user or a single subscriber. For example, the ranking may be personalised based on user activity for an individual user. Thus, although the timing of the programs is fixed by the broadcaster's schedule, the programs most likely to be liked by the user in consideration will be selected and included in a personalized virtual channel schedule.

The user activity may be associated with a plurality of content items interacted with by a plurality of users. In which case, the ranking may be based on the preferences of a user group, as opposed to an individual user. The user group may comprise all users or a subset of all users (e.g. based on a categorisation, which may be by language, demographic, likes etc.).

In some embodiments, the ranking for each content item may be based on recommendation data derived from monitoring user activity. The recommendation data may be determined by identifying, for example, collaborative content comprising content viewed by other users with similar tastes.

The method may comprise: obtaining user-derived metadata representing at least some properties associated with the plurality of content items interacted with by the at least one user; obtaining content-derived metadata representing at least some properties associated with the plurality of content items in the content schedule; and comparing the user-derived metadata with the content-derived metadata to determine the ranking for each content item.

The method may further comprise determining a first weighting for the user-derived metadata and obtaining a second weighting for the content-derived metadata and comparing the second weighting with the first weighting to determine the ranking for each content item. The weighting may relate to an importance of each piece of metadata in relation to the content.

The ranking may be based on how close the content-derived metadata for the scheduled content items matches the user-derived metadata. The ranking may comprise ordering the scheduled content items from most closely matching to least closely matching.

The method may further comprise storing the user activity and/or the interacted content items and/or metadata associated with the interacted content items in user profiles in a first memory resource remote from user devices.

In some embodiments, one or more different ranking methods may be employed, alone or in combination, for the same or different timeslots.

Once the scheduled content has been ranked and items for each timeslot selected, the virtual channel schedule may be created to include the selected content items. The virtual channel schedule may simply comprise the identifiers for the selected content items from the two or more existing channels for each timeslot.

The virtual channel schedule may be relayed to the server providing the content and/or electronic program guide to the user device 40 and the virtual channel schedule may be presented to the user a channel available for viewing. If a user selects to watch the virtual channel, the server and/or electronic program guide (EPG) will use the identifiers in the virtual channel schedule as pointers to the existing channels where the content is being broadcast. Accordingly, the user may be unaware of the channel they are actually viewing the content on and the server/EPG may automatically switch between channels according to the virtual channel schedule, without requiring any user interaction.

In some embodiments, the scheduled content items in the one or more virtual channel schedules may be selectable by a user such that the user may delete and/or replace a selected item. The selected item may be replaced by another content item scheduled to be broadcast on an existing channel in the same timeslot (i.e. a content item ranked in second or third place etc.) or the selected item may be replaced by on demand content, for example, VOD content.

In some embodiments, one or more virtual channel schedules (e.g. for a large user group) may be created by the virtual channel scheduler in advance of a request for the same, from the EPG or server. However, in other embodiments, a virtual channel schedule may only be created when requested by the EPG or server. This will most-likely be the case for personalized virtual channel schedules, which may only be created when required.

The linear broadcast content may be provided by a Free Ad-supported Streaming Television (FAST) channel provider.

The content items may comprise one or more of: television content; video content, audio content, visual content, computer games, printed content, text-based content, live performances, movies, TV programs, music, podcasts, talking books, computer games, books, magazines, news, recipes, concerts, plays, comedy performances, entertainment or sporting events.

An important technical consideration concerns the amount of data that the system and method need to contend with. For example, there may be 50 million users and user profiles associated with a given content provider, billions of content items and billions of data points (e.g. relating to the metadata). Accordingly, the system must be configured to handle such huge volumes of data in an efficient and yet accurate manner in order to provide useful results.

If a virtual channel schedule is requested in response to the initiation of a user session, there may be significant constraints on how quickly the virtual channel schedule should be provided. For example, there may be requirement that the virtual channel schedule is provided within 200 ms or 300 ms, or within any other time period that would enable the virtual channel schedule to be displayed simultaneously with, overlaid on or forming part of the EPG screen when the EPG screen is first displayed. In some embodiments the user device 40 may be configured not to display the virtual channel schedule if it is not received within a threshold time, for example within 30 s, 10 s, 5 s or 1 s by way of example, and for example to proceed with display of the EPG screen without the virtual channel schedule. Any other suitable display output may be used as well as or instead of an EPG screen in alternative embodiments, for example a window or a selected portion of a screen or window.

It can be understood that the time constraints on providing virtual channel schedules can be significant, and given that personalized virtual channel schedules may need to be generated on the fly, particularly as it may be necessary to provide personalized virtual channel schedules for tens of thousands, hundreds of thousands, or even millions of users substantially simultaneously in the case of systems with large numbers of users and during busy periods such as peak viewing periods.

It will be understood that the virtual channel scheduler 22 may maintain virtual channel creation sessions for a plurality of the users and may maintain in the RAM 7 user data for said plurality of the users substantially simultaneously. For example, user data may be maintained in the RAM 7 for thousands, hundreds of thousands or even millions of users substantially simultaneously, depending on the RAM 7 storage capacity available and the number of subscribers or other users associated with the system.

As described herein, the system and method of the present disclosure can be used advantageously to provide virtual channel schedules to users in real-time. Advantageously, the virtual channel schedule can be personalized for individual users or groups of users.

The above description of specific embodiments is made by way of example only. A skilled person will appreciate that variations of the described embodiments may be made without departing from the scope of the invention.

What is claimed is:

1. A computer-implemented method for creating a virtual channel based on linear broadcast content, the method comprising:
obtaining scheduling information and content information associated with a plurality of content items in a content schedule for two or more existing channels, the content information comprising at least an identifier for each content item;
determining, for each timeslot in a predetermined time period, a ranking for each content item scheduled in each timeslot;
selecting, for each timeslot, a content item based on the ranking; and
creating one or more virtual channel schedules comprising at least the identifier for the selected content items from the two or more existing channels.

2. The computer-implemented method of claim 1 wherein the ranking for each content item is based on one or more of: a popularity of the content items; a language of the content items; a type of the content items; metadata associated with the content items; a rule associated with the content items; or user activity associated with at least one user.

3. The computer-implemented method of claim 1, wherein the linear broadcast content is provided by a Free Ad-supported Streaming Television (FAST) channel provider.

4. The computer-implemented method of claim 2, wherein the user activity comprises interactions by the at least one user in relation to a plurality of content items.

5. The computer-implemented method of claim 2, wherein the user activity is associated with a plurality of content items interacted with by a single user or a single subscriber.

6. The computer-implemented method of claim 4, wherein the user activity is associated with a plurality of content items interacted with by a plurality of users.

7. The computer-implemented method of claim 1, further comprising providing the one or more virtual channel schedules for display.

8. The computer-implemented method of claim 1, wherein the scheduled content items in the one or more virtual channel schedules may be selectable by a user such that the user may delete and/or replace a selected item.

9. The computer-implemented method of claim 8, wherein the selected item may be replaced by another content item scheduled to be broadcast on an existing channel in the same timeslot.

10. The computer-implemented method of claim 8, wherein the selected item may be replaced by on demand content.

11. The computer-implemented method of claim 4, comprising:
obtaining user-derived metadata representing at least some properties associated with the plurality of content items interacted with by the at least one user;
obtaining content-derived metadata representing at least some properties associated with the plurality of content items in the content schedule; and
comparing the user-derived metadata with the content-derived metadata to determine the ranking for each content item.

12. The computer-implemented method of claim 11, further comprising determining a first weighting for the user-derived metadata and obtaining a second weighting for the content-derived metadata and comparing the second weighting with the first weighting to determine the ranking for each content item.

13. The computer-implemented method of claim 12, wherein the ranking is based on how close the content-derived metadata for the scheduled content items matches the user-derived metadata.

14. The computer-implemented method of claim 4, wherein the plurality of content items interacted with by the at least one user comprises content items having been one or more of: selected, viewed, recorded, purchased, read, listened to, played, shared, content rated, commented on, downloaded, watched, bookmarked, browsed, added to a shopping basket, watched or listened to a trailer, clicked on a search result, remotely recorded, set a reminder for, liked, disliked, tweeted, posted on social media, played purchased content, stopped watching, stopped playing or otherwise interacted with.

15. The computer-implemented method of claim 11, wherein the content-derived metadata and/or the user-derived metadata comprises data relating to one or more of: actor; audience; award; category; character; character type; concept source; director; format; franchise; host; milieu; mood; producer; person; singer; subcategory; scenario; setting; sports competition; studio; style; subject; team; theme; time period; and writer.

16. The computer-implemented method of claim 1, wherein the content items comprise one or more of: television content; video content, audio content, visual content, computer games, printed content, text-based content, live performances, movies, TV programs, music, podcasts, talking books, computer games, books, magazines, news, recipes, concerts, plays, comedy performances, entertainment or sporting events.

17. The computer-implemented method of claim 4, further comprising storing the user activity and/or the interacted content items and/or metadata associated with the interacted content items in user profiles in a first memory resource remote from user devices and/or storing the scheduled content items and/or metadata associated with the scheduled content items in one or more content memory resource.

18. The computer-implemented method of claim 5, further comprising determining a personalised ranking for multiple users at substantially a same time; selecting, for each timeslot and each of the multiple users, a content item based on the ranking; and creating one or more virtual channel schedules for each of the multiple users, said virtual channel schedules comprising at least the identifier for the selected content items.

19. A system for creating a virtual channel based on linear broadcast content, the system comprising processing circuitry configured to:
obtain scheduling information and content information associated with a plurality of content items in a content schedule for two or more existing channels, the content information comprising at least an identifier for each content item;
determine, for each timeslot in a predetermined time period, a ranking for each content item scheduled in each timeslot;
select, for each timeslot, a content item based on the ranking; and
create one or more virtual channel schedules comprising at least the identifier for the selected content items from the two or more existing channels.

20. A non-transitory computer-readable medium that comprises computer-readable instructions that are executable to perform a method for creating a virtual channel based on linear broadcast content, the method comprising:
obtaining scheduling information and content information associated with a plurality of content items in a content schedule for two or more existing channels, the content information comprising at least an identifier for each content item;
determining, for each timeslot in a predetermined time period, a ranking for each content item scheduled in each timeslot;
selecting, for each timeslot, a content item based on the ranking; and
creating one or more virtual channel schedules comprising at least the identifier for the selected content items from the two or more existing channels.
